(19) United States
(12) Patent Application Publication
(10) Pub. No.: US 2024/0387137 A1
(43) Pub. Date: Nov. 21, 2024

(54) RELAY

(71) Applicant: Xiamen Hongfa Electric Power Controls Co., Ltd., Xiamen (CN)

(72) Inventors: Wenguang DAI, Xiamen (CN); Zengguang ZHENG, Xiamen (CN); Fangneng LI, Xiamen (CN); Shuming ZHONG, Xiamen (CN)

(21) Appl. No.: 18/668,130

(22) Filed: May 18, 2024

(30) Foreign Application Priority Data
May 18, 2023 (CN) 202310568095.6

(51) Int. Cl. H01H 50/58; H01H 50/34

(52) U.S. Cl. CPC H01H 50/58; H01H 50/34

(57) ABSTRACT

A relay, includes a base; a contact part disposed on the base and including two sets of movable contact parts, each set of the movable contact parts including a movable contact piece, a movable contact unit and a static contact unit, stiffnesses of two movable contact pieces are difference; a push rod assembly including a first push rod and a second push rod respectively connected to the two movable contact pieces; and a magnetic circuit part arranged on the base for driving the movements of the first push rod and the second push rod in an opposite directions, so as to drive the two movable contact pieces to come into contact or move away from each other, achieving contact or separation between the static contact unit and the movable contact unit.

### CROSS-REFERENCE TO RELATED APPLICATION(S)

This application is based upon and claims priority to Chinese Patent Application No. 202310568095.6, filed on May 18, 2023, the entire contents thereof are incorporated herein by reference.

### TECHNICAL FIELD

The present disclosure relates to the field of electronic control device technology, specifically to a relay.

### BACKGROUND

A relay is an electronic control device that has a control system (also known as an input circuit) and a controlled system (also known as an output circuit), and is typically used in automatic control circuits. Essentially, the relay is an “automatic switch” that uses a smaller current to control a larger current. Therefore, it plays roles such as automatic regulation, safety protection, and circuit switching in electrical circuits.

The relay includes a magnetic circuit part, a push rod assembly, and a contact part. The magnetic circuit part includes a coil assembly and an armature assembly. The coil assembly is used to drive the movement of the armature assembly, and then drive the contacts of the contact part to connect or disconnect through the push rod assembly.

However, in existing technology, utilization rate of a magnetic driving force generated by the coil assembly after being energized is not high, and it cannot be differentiated treatment for different contact conditions.

### SUMMARY

A relay according to the embodiment of the present disclosure includes:
a base;
a contact part disposed on the base and including two sets of movable contact parts, each set of the movable contact parts including a movable contact piece, a movable contact unit and a static contact unit, the movable contact unit being arranged on the movable contact piece; two movable contact units of the contact part corresponding to two static contact units of the contact part, respectively; wherein stiffnesses of two movable contact pieces are difference;
a push rod assembly including a first push rod and a second push rod, the first push rod and the second push rod being connected to the two movable contact pieces, respectively; and
a magnetic circuit part arranged on the base and configured to drive the movements of the first push rod and the second push rod in an opposite directions, so as to drive the two movable contact pieces to come into contact or move away from each other, achieving contact or separation between the static contact unit and the movable contact unit.

According to some embodiments of the present disclosure, wherein when the contact part is in a disconnected state, a contact gap between the movable contact unit and the static contact unit corresponding to each other in one set is smaller than a contact gap between the movable contact unit and the static contact unit corresponding to each other in the other set; the movable contact unit and the static contact unit in one set with a smaller contact gap is defined as an arc-resistant end contact, and movable contact unit and the static contact unit in the other set with a larger contact gap is defined as a current-carrying end contact;
the movable contact piece provided with the movable contact unit of the current-carrying end contact is defined as a first movable contact piece, the movable contact piece provided with the movable contact unit of the arc-resistant end contact is defined as a second movable contact piece; the first push rod is connected with the first movable contact piece, the second push rod is connected with the second movable contact piece;
the stiffness of the first movable contact piece is less than the stiffness of the second movable contact piece.

According to some embodiments of the present disclosure, wherein a thickness of the first movable contact piece is less than a thickness of the second movable contact piece.

According to some embodiments of the present disclosure, wherein the first movable contact piece and the second movable contact piece respectively includes a plurality of sub-contact pieces stacked with each other;
a number of the sub-contact pieces of the first movable contact piece is less than a number of the sub-contact pieces of the second movable contact piece.

According to some embodiments of the present disclosure, wherein the movable contact unit includes one or more movable contacts, the static contact unit includes one or more static contacts, and the movable contacts and static contacts corresponding to each other form a contact set; the arc-resistant end contact includes one or more contact sets, and the current-carrying end contact includes one or more contact sets;
a number of the contact sets of the arc-resistant end contact is less than or equal to a number of the contact sets of the current-carrying end contact.

According to some embodiments of the present disclosure, wherein the arc-resistant end contact includes one or two contact sets; and
the current-carrying end contact includes two or three contact sets.

According to some embodiments of the present disclosure, wherein the arc-resistant end contact includes two contact sets, and the two contact sets are arranged side by side in a width direction of the movable contact part;
the current-carrying end contact includes two or three contact sets, and the two or three contact sets are arranged side by side in the width direction of the movable contact part.

According to some embodiments of the present disclosure, wherein a slit is provided between the two movable contacts adjacent to each other on the movable contact piece in a width direction of the movable contact piece.

According to some embodiments of the present disclosure, wherein in a length direction of the movable contact piece, one end of the slit penetrates through an end face of the movable contact piece, and the other end of the slit extends to the static contact on the movable contact piece.

According to some embodiments of the present disclosure, wherein each set of movable contact parts further includes a movable contact leading-out piece, the movable contact leading-out piece is connected to the movable contact piece;
the static contact unit is disposed at a connection position between the movable contact piece and the movable contact leading-out piece.

According to some embodiments of the present disclosure, wherein the movable contact piece has a first end and a second end opposite to the first end in its own length direction;
the movable contact unit is disposed at the first end, and the second end is connected to the movable contact leading-out piece,
the first push rod and the second push rod are respectively connected with the first ends of the two movable contact pieces.

According to some embodiments of the present disclosure, wherein the magnetic circuit part includes a coil assembly and a armature assembly, the armature assembly is pivotally connected to the base, the armature assembly is respectively connected to the first push rod and the second push rod, the coil assembly is configured to drive the armature assembly to pivot;
the first push rod and the second push rod are located at opposite sides of the armature assembly.

According to some embodiments of the present disclosure, wherein
when the contact part is in connected state, the movable contact piece with smaller stiffness is deformed under an action of the first push rod or the second push rod and has an elastic force, the elastic force makes the movable contact piece has a moving tendency to disconnect the contacts.

### BRIEF DESCRIPTION OF THE DRAWINGS

FIG. 1 illustrates a top schematic view of a relay according to an embodiment of the present disclosure, with the upper cover omitted.

FIG. 2 shows a schematic view of the relay of FIG. 1 with the base omitted, and the contact part in a disconnected state.

FIG. 3 shows a cross-sectional view of the magnetic circuit part.

FIG. 4 shows a schematic view of a contact part shown in FIG. 1.

FIG. 5 shows a three-dimensional schematic view of the contact part according to a first embodiment of the present disclosure.

FIG. 6 shows a top schematic view of one of the movable contact parts in the contact part according to the first embodiment of the present disclosure.

FIG. 7 shows an exploded schematic view of one of the movable contact parts in the contact part according to the first embodiment of the present disclosure, where the movable contact piece is not provided with a slit.

FIG. 8 shows a three-dimensional schematic view of the contact part according to a second embodiment of the present disclosure.

FIG. 9 shows a top schematic view of one of the movable contact parts in the contact part according to the second embodiment of the present disclosure.

FIG. 10 shows an exploded schematic view of one of the movable contact parts in the contact part according to the second embodiment of the present disclosure, where the movable contact piece is provided with a slit.

FIG. 11 shows a top schematic view of one of the movable contact parts in the contact part according to a third embodiment of the present disclosure.

FIG. 12 shows a top schematic view of one of the movable contact parts in the contact part according to a fourth embodiment of the present disclosure.

FIG. 13 shows a schematic view of the contact part according to a fifth embodiment of the present disclosure.

wherein, the reference numerals are listed as follows:
10: base
20: contact part
20a: movable contact part
210: movable contact piece
211: sub-contact piece
212: current carrier
213: end face
214: slit
210a: first end
210b: second end
210c: first movable contact piece
210d: second movable contact piece
210e: third movable contact piece
210f: fourth movable contact piece
220: movable contact unit
221: movable contact
230: static contact unit
231: static contact
240: movable contact leading-out piece
250: arc-resistant end contact
260: current-carrying end contact
30: magnetic circuit part
310: coil assembly
320: armature assembly
321: permanent magnet
322: armature
323: swinging arm
40: push rod assembly
410: first push rod
420: second push rod
D1: length direction
D2: width direction

### DETAILED DESCRIPTION

Now, the exemplary implementations will be described more completely with reference to the accompanying drawings. However, the exemplary implementations can be done in various forms and should not be construed as limiting the implementations as set forth herein. Instead, these implementations are provided so that the present disclosure will be thorough and complete, and concept of the exemplary implementation will be fully conveyed to those skilled in the art. Same reference numbers denote the same or similar structures in the figures, and thus the detailed description thereof will be omitted.

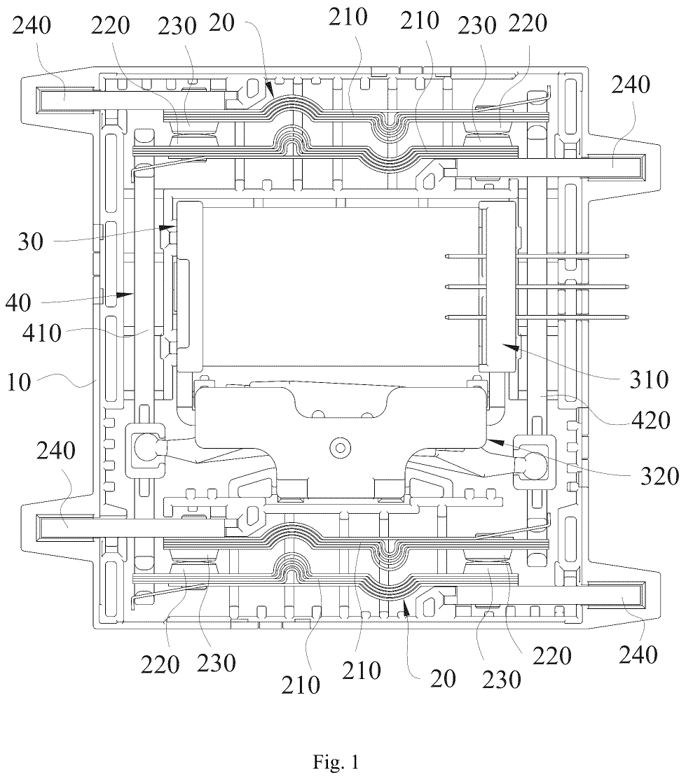

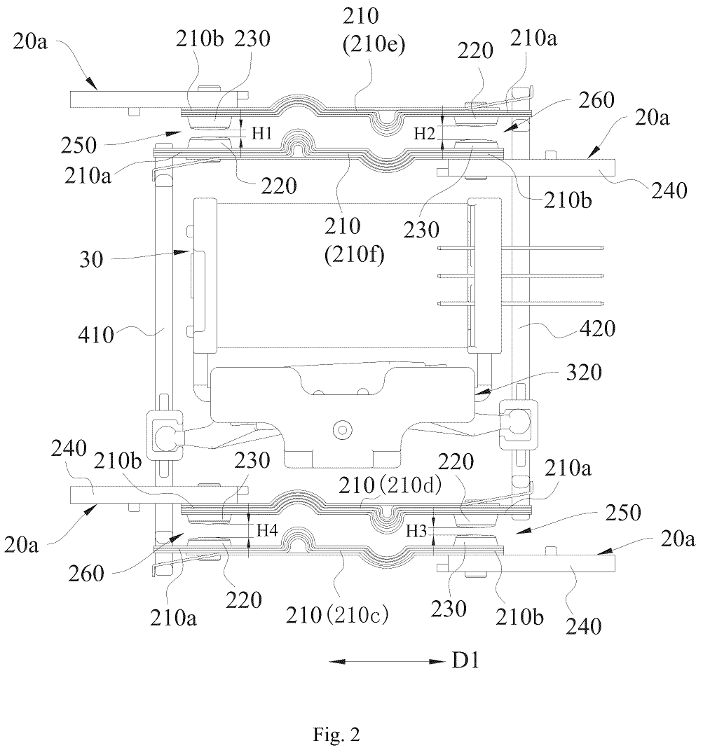

As shown in FIGS. 1 and 2, a relay according to the embodiments of the present disclosure includes a base 10, a pair of contact parts 20, a magnetic circuit part 30, and a push rod assembly 40. The pair of contact parts 20 and the magnetic circuit part 30 are disposed on the base 10 The magnetic circuit part 30 drives contacts of the pair of contact parts 20 to connect or disconnect through the push rod assembly 40.

It is understood that the terms “include” and “have” and their any variations used in the embodiments of the present disclosure are intended to cover non-exclusive inclusions. For example, a process, method, system, product, or apparatus that includes a series of steps or units is not limited to the listed steps or units, but may optionally include steps or units not listed, or may optionally include other inherent steps or components for these processes, methods, products, or apparatuses.

In one embodiment, the base 10 may be substantially cubic in shape, but is not limited thereto.

A pair of contact parts 20 may be respectively disposed on two opposite sides of the magnetic circuit part 30. Of course, the pair of the contact parts 20 may also be disposed on the same side of the magnetic circuit part 30.

Each contact part 20 includes two sets of movable contact parts 20a. Each set of movable contact parts 20a includes a movable contact piece 210, a movable contact unit 220, a static contact unit 230, and a movable contact leading-out piece 240. The movable contact piece 210 is connected to the movable contact leading-out piece 240. The movable contact unit 220 is disposed on the movable contact piece 210, and the static contact unit 230 is disposed on the movable contact piece 210 and/or the movable contact leading-out piece 240. Two movable contact units 220 of each contact part 20 correspond to two static contact units 230 of each contact part 20, respectively. The movable contact leading-out piece 240 is fixedly connected to the base 10.

The magnetic circuit part 30 is disposed on the base 10 and is used to drive the movement of four movable contact pieces 210 of the pair of contact parts 20 through the push rod assembly 40, thereby connecting and disconnecting the movable contact units 220 and the static contact units 230.

It is understood that the relay of the embodiments of the present disclosure includes a pair of contact parts 20. Each contact part 20 can control one circuit, so that the relay of the embodiments of the present disclosure can control at least two circuits.

Of course, in other embodiments, the relay may include only one contact part 20, which can control one circuit, thereby enabling the relay to control one circuit.

When the contact part 20 is in a disconnected state, a contact gap between the corresponding movable contact unit 220 and static contact unit 230 in one set is smaller than a contact gap between the corresponding movable contact unit 220 and static contact unit 230 in the other set.

As shown in FIG. 2, for the contact part 20 located above the magnetic circuit part 30, the contact gap between the movable contact unit 220 and the static contact unit 230 on the left side is H1, and the contact gap between the movable contact unit 220 and the static contact unit 230 on the right side is H2, where H1<H2.

Similarly, for the contact part 20 located below the magnetic circuit part 30, a contact gap between the movable contact unit 220 and the static contact unit 230 on the right side is H3, and the contact gap between the movable contact unit 220 and the static contact unit 230 on the left side is H4, where H3<H4.

It should be added that the design of different contact gaps between the two sets of movable contact units 220 and static contact units 230 can be achieved by reducing height of the contacts. Specifically, as shown in FIG. 2, taking the contact part 20 located above the magnetic circuit part 30 as an example, a contact height of the movable contact unit 220 and the static contact unit 230 on the right side is smaller than a contact height of the movable contact unit 220 and the static contact unit 230 on the left side, so that when the contact part 20 is in the disconnected state, due to the smaller contact height on the right side compared to the left side, the contact gap between the movable contact unit 220 and the static contact unit 230 on the right side is larger, and greater than the contact gap on the left side.

Of course, the design of different contact gaps can also be achieved by other methods, which are not listed one by one here, as long as it is possible to have different contact gaps between the two sets of movable contact units 220 and static contact units 230 when the contact part 20 is in the disconnected state, all of which are within the scope of protection of the present disclosure.

It is understood that in the contact part 20 of the embodiments of the present disclosure, since the contact gaps between the two sets of movable contact units 220 and static contact units 230 are different when in the disconnected state, during the transition from a connected state to a disconnected state, the set of the movable contact unit 220 and the static contact unit 230 with the larger contact gap therebetween will be disconnected prior to the set of the movable contact unit 220 and the static contact unit 230 with the smaller contact gap. At the moment when the set of the movable contact unit 220 and the static contact unit 230 with the larger contact gap has just disconnected, the set of the movable contact unit 220 and the static contact unit 230 with the smaller contact gap has not yet fully disconnected. Therefore, the set of the movable contact unit 220 and the static contact unit 230 with the larger contact gap plays a current-carrying role, while the set of the movable contact unit 220 and the static contact unit 230 with the smaller contact gap plays an arc-resistant role. Since the set of the movable contact unit 220 and the static contact unit 230 with the larger contact gap does not produce an arc when disconnecting. Therefore, only the set of the movable contact unit 220 and the static contact unit 230 with the smaller contact gap needs to be controlled for the contact parameters of the entire contact part 20, without considering the set of the movable contact unit 220 and the static contact unit 230 with the larger contact gap. Compared to the multi-contact design in the existing technology, the contact parameters of the contact part 20 of the embodiments of the present disclosure are easier to control and simpler to process, which is beneficial for improving production efficiency.

As an example, in each set of movable contact parts 20a, the static contact unit 230 is disposed at a connection position between the movable contact piece 210 and the movable contact leading-out piece 240.

As shown in FIGS. 1 and 2, the movable contact piece 210 has a first end 210a and a second end 210b opposite to each other along its own length direction D1. The movable contact unit 220 is disposed at the first end 210a, and the static contact unit 230 is disposed at the second end 210b. Moreover, the second end 210b of the movable contact piece 210 is connected to the movable contact leading-out piece 240, so that the static contact unit 230 is disposed at a connection position between the second end 210b of the movable contact piece 210 and the movable contact leading-out piece 240.

In the contact part 20, two movable contact pieces 210 are parallel with each other. The movable contact unit 220 at the first end 210a of one of the movable contact pieces 210 corresponds to the static contact unit 230 at the second end 210b of the other of the movable contact pieces 210, such that two pairs of the movable contact units 220 and the static contact units 230 after being connected form a circuit structure in parallel. The design of the contact part 20 as a parallel circuit structure can effectively reduce a temperature rise.

As shown in FIGS. 1 and 2, the push rod assembly 40 includes a first push rod 410 and a second push rod 420, which are respectively disposed on the other two opposite sides of the magnetic circuit part 30. The magnetic circuit part 30 is drivable connected with the first push rod 410 and the second push rod 420, respectively, so as to drive the first push rod 410 and the second push rod 420 to reciprocate.

One end of the first push rod 410 is connected to the first end 210a of one of the movable contact pieces 210 in one of the contact parts 20, and the other end of the first push rod 410 is connected to the first end 210a of the other of the movable contact pieces 210 in the other of the contact parts 20. The one end of the second push rod 420 is connected to the first end 210a of the other of the movable contact pieces 210 in one of the contact parts 20, and the other end of the second push rod 420 is connected to the first end 210a of the other of the movable contact pieces 210 in the other of the contact parts 20.

In this embodiment, the push rod assembly 40 adopts a dual push rod structure with the first push rod 410 and the second push rod 420, and the connecting or disconnecting of the contacts can be achieved through the push-pull movement of the dual push rod structure.

Specifically, as shown in FIG. 2, the movement directions of the first push rod 410 and the second push rod 420 are opposite. If the first push rod 410 moves downwards, then the second push rod 420 moves upwards. Since the first push rod 410 moves downwards, the two movable contact pieces 210 connected to the first push rod 410 both pivot downwards around their respective second ends 210b. Since the second push rod 420 moves upwards, the two movable contact pieces 210 connected to the second push rod 420 both pivot upwards around their respective second ends 210b. In one contact part 20, the two movable contact pieces 210 pivot in opposite directions and move away from each other, thereby achieving the disconnection of the movable contact unit 220 and the static contact unit 230.

Conversely, if the first push rod 410 moves upwards, then the second push rod 420 moves downwards. The two movable contact pieces 210 connected to the first push rod 410 both pivot upwards around their respective second ends 210b, and the two movable contact pieces 210 connected to the second push rod 420 both pivot downwards around their respective second ends 210b. In one contact part 20, the two movable contact pieces 210 pivot in opposite directions and move towards each other, achieving the connection of the movable contact unit 220 and the static contact unit 230.

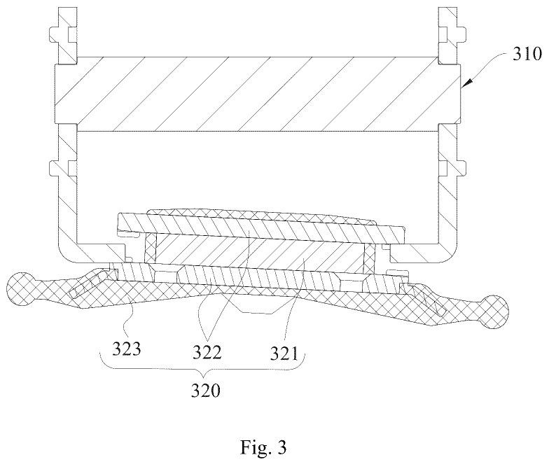

As shown in FIG. 3, the magnetic circuit part 30 includes a coil assembly 310 and an armature assembly 320, the armature assembly 320 is pivotally connected to the base 10. The coil assembly 310 is used to drive the armature assembly 320 to pivot relative to the base 10. The armature assembly 320 includes a permanent magnet 321, an armature 322, and a swinging arm 323. There are two armatures 322, and the permanent magnet 321 is clamped between the two armatures 322. The swinging arm 323 may be made of an insulating material, such as plastic. The permanent magnet 321, the armature 322, and the swinging arm 323 may be integrally connected by an injection molding. Two ends of the swinging arm 323 are respectively connected to the first push rod 410 and the second push rod 420.

By changing a direction of a magnetic field of the coil assembly 310 to drive the armature assembly 320 to pivot relative to the base 10. The swinging arm 323 of the armature assembly 320 respectively drive the reciprocated movement of the first push rod 410 and the second push rod 420, so as to achieve the connection or disconnection of the movable contact unit 220 and the static contact unit 230.

The stiffness of the two movable contact piece 210 of the contact part 20 is different. For convenience of explanation, two movable contact pieces 210 under the magnetic circuit part 30 in FIG. 2 are defined as the first movable contact piece 210c and the second movable contact piece 210d respectively, and two movable contact pieces 210 under the magnetic circuit part 30 in FIG. 2 are defined as the third movable contact piece 210e and the fourth movable contact piece 210f. The stiffness of the first movable contact piece 210c and the second movable contact piece 210d is different, the stiffness of the third movable contact piece 210e and the fourth movable contact piece 210f is different.

It should be noted that the stiffness refers to the ability of a material or structure to resist elastic deformation when stressed. The greater the stiffness, the stronger the ability of a material or structure to resist elastic deformation when stressed; The smaller the stiffness, the weaker the ability of a material or structure to resist elastic deformation under stress. In the embodiment of the present invention, because the stiffness of the first movable contact piece 210c is different from that of the second movable contact piece 210d, the ability of the first movable contact piece 210c and the second movable contact piece 210d to resist elastic deformation under stress is different. Because the stiffness of the third movable contact piece 210e and the fourth movable contact piece 210f is different, the ability of the first movable contact piece 210e and the second movable contact piece 210f to resist elastic deformation under stress is different.

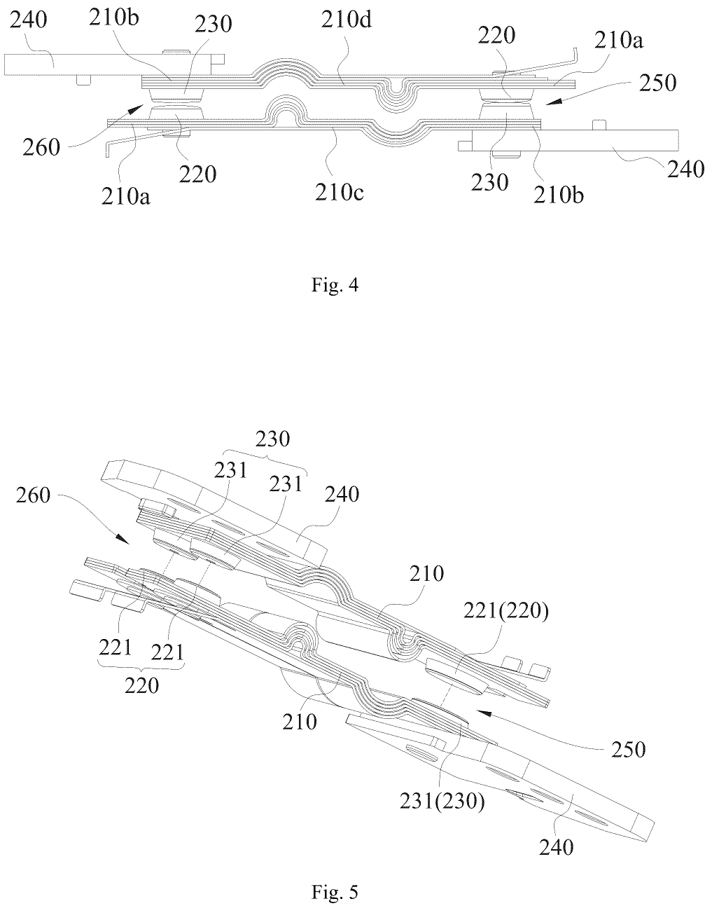

In conjunction with FIGS. 2 and 4, one end of the first push rod 410 is connected with the first end 210a of the first movable contact piece 210c, and the other end of the first push rod 410 is connected with the first end 210a of the fourth movable contact piece 210f. One end of the second push rod 420 is connected with the first end 210a of the second movable contact piece 210d, and the other end of the second push rod 420 is connected with the first end 210a of the third movable contact piece 210e. The first push rod 410 is used to drive the first movable contact piece 210c and the fourth movable contact piece 210f to pivot about their respective second ends 210b, and the second push rod 420 is used to drive the second movable contact piece 210d and the third movable contact piece 210e to pivot about their respective second ends 210b.

It can be understood that the coil assembly 310, after being energized, can drive the armature assembly 320 to pivot relative to the base 10. For example, when the coil assembly 310 passes a positive current, the armature assembly 320 pivots clockwise; when the coil assembly 310 passes a negative current, the armature assembly 320 pivots counterclockwise.

It is required that a coil driving force generated by the energized coil assembly 310 overcomes a magnetic holding force of the permanent magnet 321 and elastic forces of the four movable contact pieces 210 connected to the first push rod 410 and the second push rod 420, respectively. Only when the coil driving force is greater than a sum of the magnetic holding force and the elastic forces, can the armature assembly 320 pivot.

When the contact part 20 transits from the connected state to the disconnected state, the first push rod 410 pushes the first movable contact piece 210c to pivot downward, the second push rod 420 pushes the third movable contact piece 210e to pivot upward; At the same time, the first push rod 410 pulls the fourth movable contact piece 210f to pivot downward, the second push rod 420 pulls the second movable contact piece 210d to pivot upward. Since the stiffnesses of the first movable contact piece 210c and the second movable contact piece 210d are different, and the stiffnesses of the third movable contact piece 210e and the fourth movable contact piece 210f are different, thus, the elastic deformation ability of the first movable contact piece 210c against the pushing force of the first push rod 410, the elastic deformation ability of the third movable contact piece 210e against the pushing force of the second push rod 420, the elastic deformation ability of the second movable contact piece 210d against the pulling force of the second push rod 420 and the elastic deformation ability of the fourth movable contact piece 210f against the pulling force of the first push rod 410 are different. So, on the whole, the sum of the breaking force required for disconnecting the contacts formed the contact gap H4 and the breaking force required for disconnecting the contacts formed the contact gap H2 should be less than The sum of the breaking force required for disconnecting the contacts formed the contact gap H1 and the breaking force required for disconnecting the contacts formed the contact gap H3. That is, the breaking forces of the first push rod 410 and the second push rod 420 acting on the first movable contact piece 210c and the third movable contact piece 210e, and the breaking forces acting on the first movable contact piece 210d and the third movable contact piece 210f are different. Therefore, the relay in the embodiment of the present invention can perform differential treatment on the breaking force of two push rods according to different contact conditions, thereby reducing unnecessary energy loss and improving the utilization rate of the overall coil driving force.

It should be noted that by changing the thickness, length, material, and other factors of the two corresponding movable contact pieces 210, different stiffness can be obtained.

Of course, two corresponding movable contact pieces 210 can be different from each other in terms of thickness, length, material, or any combination of multiple variables, as long as the stiffnesses of the two corresponding movable contact pieces 210 is different.

In the embodiments of the present disclosure, the thicknesses of the two corresponding movable contact pieces 210 are different.

The set of the movable contact unit 220 and the static contact unit 230 with a smaller contact gap is defined as an arc-resistant end contact 250, and the set of the movable contact unit 220 and the static contact unit 230 with a larger contact gap is defined as a current-carrying end contact 260.

In the contact part 20 under the magnetic circuit part 30, the movable contact piece 210 provided with the movable contact unit of the current-carrying end contact 260 is defined as the first movable contact piece 210c, the movable contact piece 210 provided with the movable contact unit of the arc-resistant end contact is defined as the second movable contact piece 210d. the stiffness of the first movable contact piece 210c is less than the stiffness of the second movable contact piece 210d.

In the contact part 20 upper the magnetic circuit part 30, the movable contact piece 210 provided with the movable contact unit of the current-carrying end contact 260 is defined as the third movable contact piece 210e, the movable contact piece 210 provided with the movable contact unit of the arc-resistant end contact 250 is defined as the fourth movable contact piece 210f. The stiffness of the third movable contact piece 210e is less than the stiffness of the fourth movable contact piece 210f.

It should be noted that since the contact gap between the arc-resistant end contact 250 is smaller, it is prone to generate an adhesion force when the contacts are disconnected, which may cause the relay to fail to disconnect reliably. Therefore, compared to the current-carrying end contact 260, the arc-resistant end contact 250 requires a greater driving force to achieve reliable disconnection.

In the embodiments of the present disclosure, the contacts formed the contact gaps H4 and H2 are the current-carrying end contacts 260, the contacts formed the contact gaps H1 and H3 are the arc-resistant end contacts 250.

In this embodiment, since the stiffness of the first movable contact piece 210c is less than that of the second movable contact piece 210d, so the elastic deformation ability of the first movable contact piece 210c against the pushing force of the first push rod 410 is weaker than the elastic deformation ability of the second movable contact piece 210d against the pulling force of the second push rod 420, thereby during the contact part 20 transits from the connected state to the disconnected state, the current-carrying end contact 260 corresponding to the contact gap H4 only needs smaller breaking force provided by the first push rod 410 for breaking. since the stiffness of the third movable contact piece 210e is less than since the stiffness of the fourth movable contact piece 210f, so the elastic deformation ability of the third movable contact piece 210e against the pushing force of the second push rod 420 is weaker than so the elastic deformation ability of the fourth movable contact piece 210f against the pulling force of the first push rod 410, during the contact part 20 transits from the connected state to the disconnected state, the current-carrying end contact 260 corresponding to the contact gap H2 only needs smaller breaking force provided by the second push rod 420 for breaking.

Thus, on the premise that the driving force provided by the coil assembly 310 remains unchanged, since the current-carrying end contact 260 corresponding to the contact gap H4 and the current-carrying end contact 260 corresponding to the contact gap H2 need smaller breaking force, so the breaking force acting on the arc-resistant end contact 250 corresponding to the contact gap H3 at the lower end of the second push rod 420, and the breaking force acting on the arc-resistant end contact 250 corresponding to the contact gap H1 at the upper end of the second push rod 420 become larger. In this way, the breaking force of two arc-resistant end contacts 250 can be increased, and the arc-resistant end contacts 250 can realize reliable breaking under the action of larger breaking force. Thus, the breaking force of the current-carrying end contact 260 is reduced, while the breaking force of the arc-resistant end contact 250 is increased, and unnecessary energy loss is reduced. The relay of the embodiments of the present disclosure has both advantages of being easy to control the parameters of the arc-resistant end contact 250 without considering the parameters of the current-carrying end contact 260, and improving the reliability of breaking the arc-resistant end contact 250.

Of course, it can be understood that the embodiments with one, three or other numbers of the contact part 20 also have the advantages of reducing the breaking force of the current-carrying end contact and increasing the breaking force of the arc-resistant end contact, which will not be described here.

As shown in FIG. 2, in the contact part 20 located above the magnetic circuit part 30, the movable contact unit 220 and the static contact unit 230 on the left side are defined as the arc-resistant end contact 250, and the movable contact unit 220 and the static contact unit 230 on the right side are defined as the current-carrying end contact 260; in the contact part 20 located below the magnetic circuit part 30, the movable contact unit 220 and the static contact unit 230 on the right side are defined as the arc-resistant end contact 250, and the movable contact unit 220 and the static contact unit 230 on the left side are defined as the current-carrying end contact 260.

That is to say, in the embodiment of the present disclosure, two arc-resistant end contacts 250 are located on a diagonal line of the base 10. Two ends of the first push rod 410 respectively correspond to one current-carrying end contact 260 and one arc-resistant end contact 250, and the two ends of the second push rod 420 respectively correspond to one current-carrying end contact 260 and one arc-resistant end contact 250. That is to say, the two sets of contact part 20 are symmetrically arranged in the center. In this way, parts can be shared between two sets of contact part 20, which is convenient for automatic production. In addition, the assembly process can be reduced, thereby reducing the assembly error rate and improving the product yield rate.

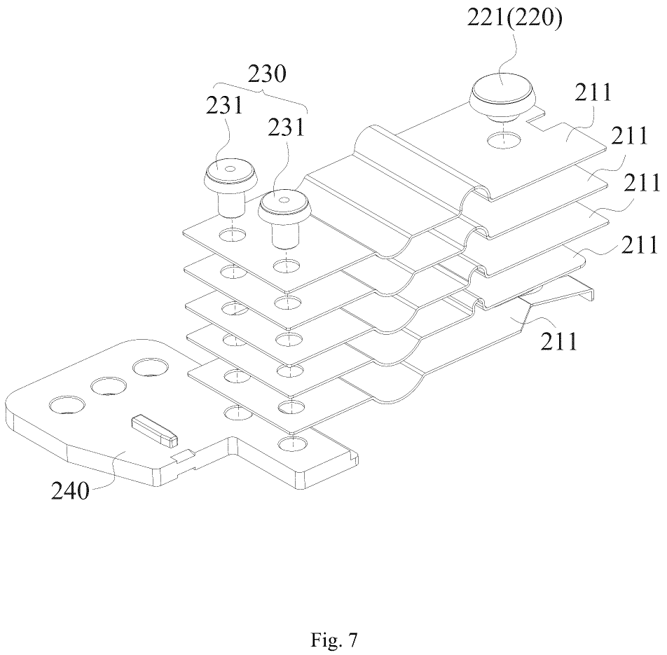

As shown in FIGS. 4 and 7, the thickness of the first movable contact piece 210c is smaller than that of the second movable contact piece 210d. Under the condition that the materials, lengths and other variables of the two movable contact pieces 210 are unchanged, only by changing the thickness of the first movable contact piece 210c and the second movable contact piece 210d, the stiffness of the first movable contact piece 210c and the second movable contact piece 210d can be changed.

Further, the first movable contact piece 210c and the second movable contact piece 210d respectively includes a plurality of sub-contact pieces 211 stacked with each other. By designing the movable contact piece 210 to include a plurality of sub-contact pieces 211 stacked with each other, on the one hand, the thickness of the sub-contact pieces 211 is thin, and the movable contact piece 210 can be made of a thin strip material with lower material cost; on the other hand, By increasing or decreasing the number of the sub-contact piece 211, the thickness of the movable contact piece 210 can be changed, and then the stiffness of two movable contact pieces 210 can be changed, which is convenient for operation.

As an example, the first movable contact piece 210c includes four sub-contact pieces 211, and the second movable contact piece 210d includes five sub-contact pieces 211. But it is not limited to this.

It can be understood that, the thickness of the third movable contact piece 210e is less than that of the fourth movable contact piece 210f. The design of the third movable contact piece 210e and the fourth movable contact piece 210f can refer to the first movable contact piece 210c and the second movable contact piece 210d, and will not be repeated here.

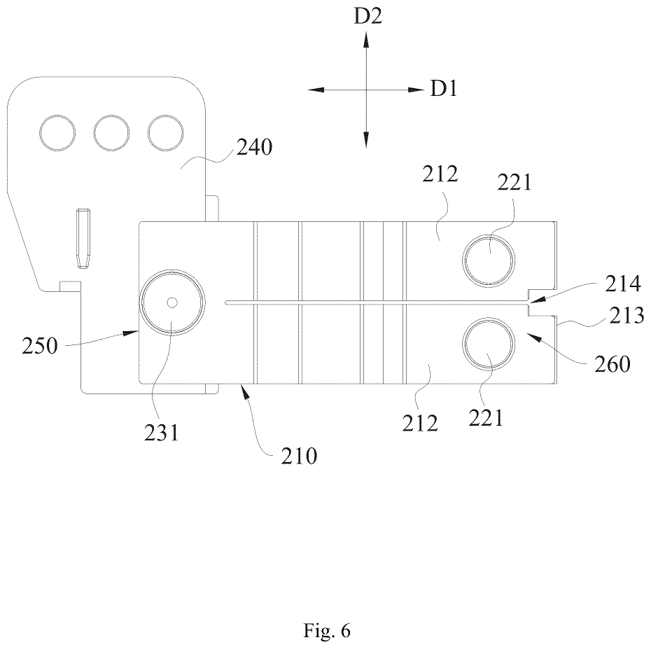

As shown in FIGS. 5 and 6, the movable contact unit 220 includes one or more movable contacts 221, and the static contact unit 230 includes one or more static contacts 231. The movable contact 221 and the static contact 231 corresponding to each other form a contact set. The arc-resistant end contact 250 includes one or more contact sets. The current-carrying end contact 260 includes one or more contact sets. The number of the contact sets in the arc-resistant end contacts 250 is less than or equal to the number of contact sets in the current-carrying end contact 260.

In this embodiment, both the arc-resistant end contact 250 and the current-carrying end contact 260 may respectively be configured to include a plurality of contact sets, such that a parallel structure formed by the plurality of contact sets can further reduce a temperature rise of the relay. Moreover, since the current-carrying end contact 260 plays a current-carrying role and the arc-resistant end contact 250 plays an arc-resistant role, the number of the contact sets in the arc-resistant end contact 250 is designed to be less than or equal to the number of the contact sets in the current-carrying end contact 260. This not only increases the number of the contact sets in the current-carrying end contact 260 to reduce the temperature rise but also controls the number of the contact sets in the arc-resistant end contact 250, facilitating the management of contact parameters, ultimately achieving a situation where the increase in the contact sets does not affect the management of the contact parameters.

As shown in FIGS. 5 and 6, in the embodiments of the present disclosure, the contact part 20 includes three sets of contact sets, among which the number of contact sets of the arc-resistant end contact 250 is 1, and the number of contact sets of the current-carrying end contact 260 is 2. The two contact sets of the current-carrying end contact 260 are arranged side by side along a width direction D2 of the movable contact piece 210.

Please continue to refer to FIG. 6, along the width direction D2 of the movable contact piece 210, a slit 214 is provided between the two movable contacts 221 adjacent to each other on the movable contact piece 210. Furthermore, along a length direction D1 of the movable contact piece 210, one end of the slit 214 penetrates through an end face 213 of the movable contact piece 210, and the other end of the slit 214 extends to the static contact 231 on the movable contact piece 210.

In this embodiment, by providing a slit 214 on the movable contact piece 210, the movable contact piece 210 is divided into a plurality of current carriers 212 by the slit 214. The movable contacts 221 on the movable contact piece 210 are provided correspondingly on the plurality of current carriers 212. Thus, the movable contacts 221 on the movable contact piece 210 can move relatively independently, enabling the movable contacts 221 to reliably contact the static contact 231, avoiding a situation where some of the movable contacts 221 on the movable contact piece 210 have already contacted the static contact 231, while the other movable contacts 221 have not yet contacted the static contact 231, thereby improving contact reliability of the contacts.

Of course, in other embodiments, a slit 214 may not be provided on the movable contact piece 210.

The movable contacts 221 and the static contacts 231 are provided on the movable contact pieces 210. It can be understood that the movable contacts 221 may be connected to the movable contact pieces 210 in an integral or separate manner, and the static contacts 231 can also be connected to the movable contact pieces 210 in an integral or separate manner.

When the movable contacts 221 and the static contacts 231 are connected to the movable contact pieces 210 in the separate manner, the connection method may be riveting, but this is not limited thereto.

Of course, in other embodiments, the movable contact pieces 210 may also be an integral piece, without the multi-layer sub-contact pieces 211 stacked with each other.

For the arc-resistant end contact, since the number of contact set is small, the volume of each contact can be designed to be larger, and the silver layer arranged on the contact is more resistant to burning, which improves the durability of the contact. Moreover, the arc-resistant end contact has fewer contact sets, which is convenient for measuring contact parameters. For the current-carrying end contact, there are more contact sets, forming a multi-contact parallel structure, thereby reducing the temperature rise.

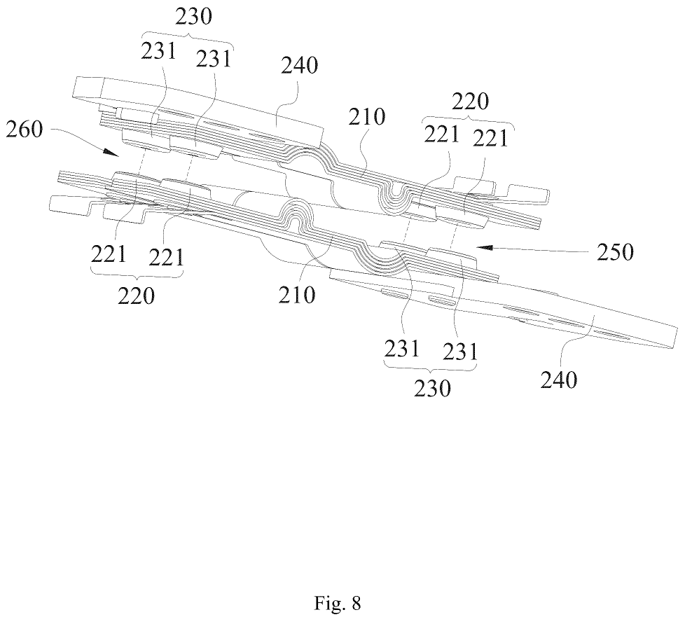

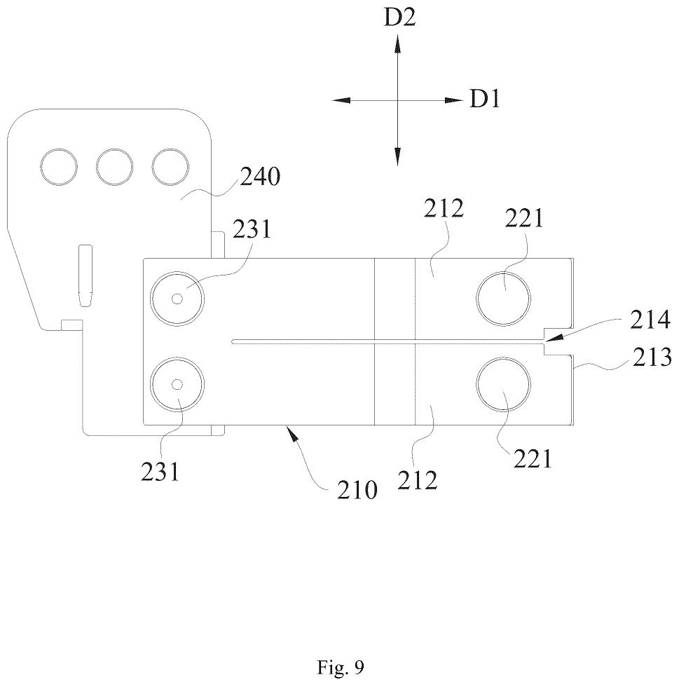

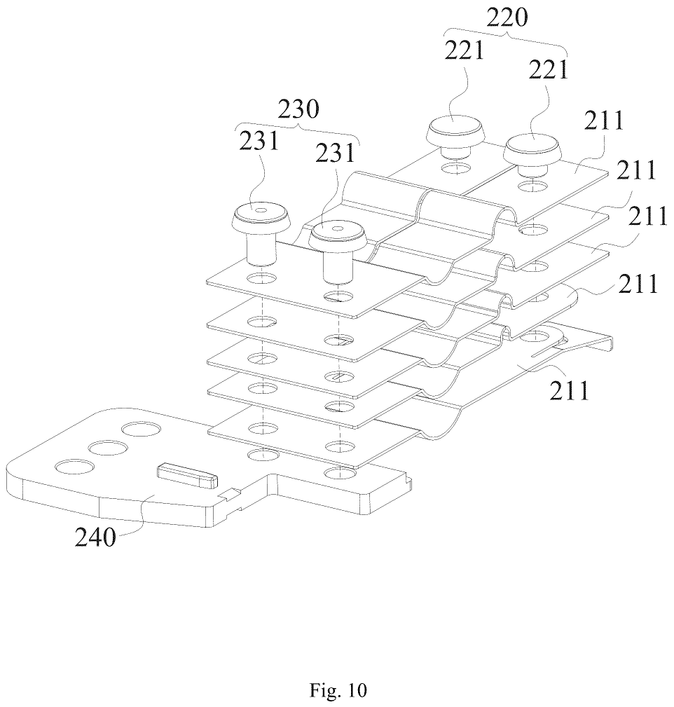

As shown in FIGS. 8 to 10, compared to the contact part 20 of the first embodiment, the contact part 20 of the second embodiment has a substantially similar structure in the basic configuration. Therefore, in the following description of the contact part 20 of the second embodiment, the structures already described in the first embodiment will not be repeated. In addition, the structures in the contact part 20 of the second embodiment that are the same as those described in the first embodiment will be denoted by the same reference numerals. Therefore, in the following description of the present embodiment, the differences between the contact part 20 of the second embodiment and the contact part 20 of the first embodiment will be mainly described.

In this embodiment, the contact part 20 includes four sets of contacts, among which the number of contact sets of the arc-resistant end contact 250 is 2, and the number of contact sets of the current-carrying end contact 260 is 2. The two contact sets of the arc-resistant end contact 250 and the two contact sets of the current-carrying end contact 260 are respectively arranged along the width direction D2 of the movable contact piece 210.

The movable contact piece 210 may be provided with a slit 214, or not.

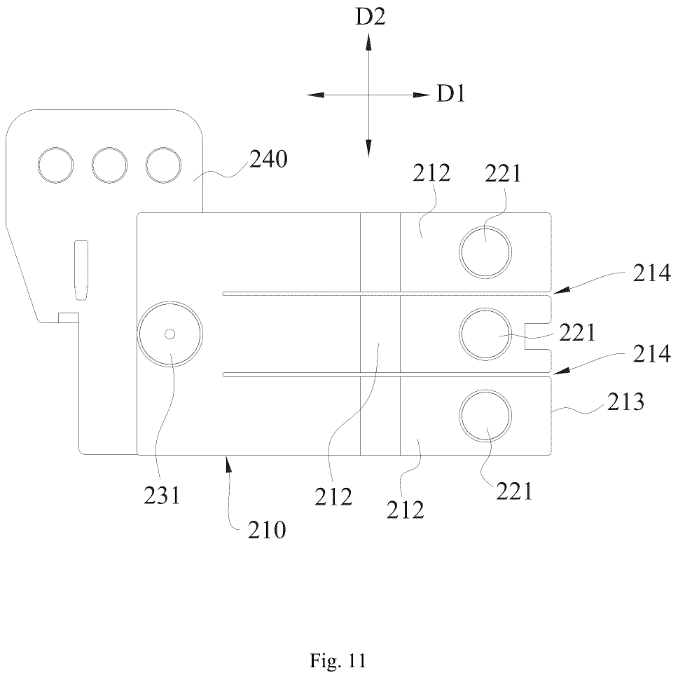

As shown in FIG. 11, compared to the contact part 20 of the second embodiment, the contact part 20 of the third embodiment has a substantially similar structure in its basic configuration. Therefore, in the following description of the contact part 20 of the third embodiment, the structures already described in the second embodiment will not be repeated. In addition, the structures in the contact part 20 of the third embodiment that are the same as those described in the second embodiment will be denoted by the same reference numerals. Therefore, in the following description of the present embodiment, the differences between the contact part 20 of the third embodiment and the contact part 20 of the second embodiment will be mainly described.

In this embodiment, the contact part 20 includes four sets of contact sets, among which the number of contact sets of the arc-resistant end contact 250 is 1, and the number of contact sets of the current-carrying end contact 260 is 3. Among the current-carrying end contact 260, three sets of contact sets are arranged side by side along the width direction D2 of the movable contact piece 210.

The movable contact piece 210 may be provided with a slit 214, or not.

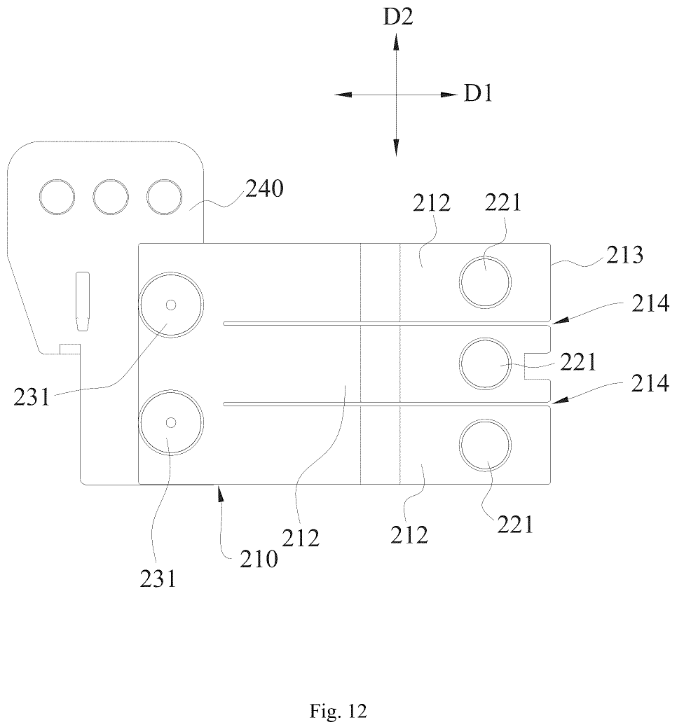

As shown in FIG. 12, compared to the contact part 20 of the first embodiment, the contact part 20 of the fourth embodiment has a substantially similar structure in its basic configuration. Therefore, in the following description of the contact part 20 of the fourth embodiment, the structures already described in the first embodiment will not be repeated. In addition, the structures in the contact part 20 of the fourth embodiment that are the same as those described in the first embodiment will be denoted by the same reference numerals. Therefore, in the following description of the present embodiment, the differences between the contact part 20 of the fourth embodiment and the contact part 20 of the first embodiment will be mainly described.

In this embodiment, the contact part 20 includes five sets of contact sets, among which the number of contact sets of the arc-resistant end contact 250 is 2, and the number of contact sets of the current-carrying end contact 260 is 3.

In the arc-resistant end contact 250, two sets of contacts are arranged side by side along the width direction D2 of the movable contact piece 210. In the current-carrying end contact 260, three sets of contacts are arranged side by side along the width direction D2 of the movable contact piece 210.

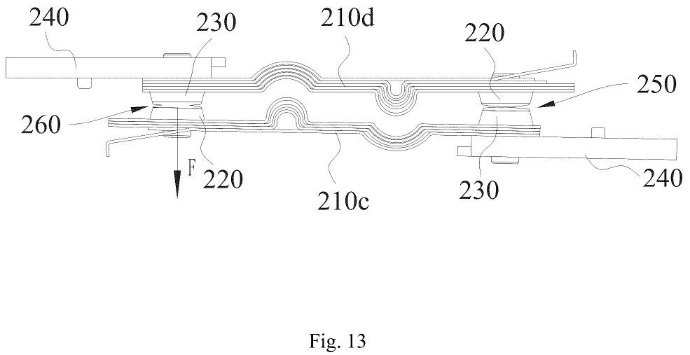

As shown in FIG. 13, compared to the contact part 20 of the first embodiment, the contact part 20 of the fifth embodiment has a substantially similar structure in its basic configuration. Therefore, in the following description of the contact part 20 of the fifth embodiment, the structures already described in the first embodiment will not be repeated. In addition, the structures in the contact part 20 of the fifth embodiment that are the same as those described in the first embodiment will be denoted by the same reference numerals. Therefore, in the following description of the present embodiment, the differences between the contact part 20 of the fifth embodiment and the contact part 20 of the first embodiment will be mainly described.

In this embodiment, when the contact part 20 is in the connected state, the movable contact piece 210 with small stiffness is deformed under the action of the first push rod 410 or the second push rod 420 and has elastic force, which makes the movable contact piece 210 has a moving tendency to disconnect the contacts.

As shown in FIG. 2 and FIG. 13, the first movable contact piece 210c is deformed under the pulling force of the first push rod 410 and has an elastic force F, when the contact part 20 transits from a connected state to a disconnected state, The elastic force F makes the first movable contact piece 210c tend to move away from the second movable contact piece 210d. In this way, under the action of elastic force F, the breaking force of the first push rod 410 breaking the current-carrying end contact 260 becomes smaller; Furthermore, the breaking force of the second push rod 420 breaking the arc-resistant end contact 250 becomes larger, which is helpful for the arc-resistant end contact 250 to break in time.

It can be understood that the various examples/embodiments provided by the present disclosure can be combined with each other without contradiction, and detailed examples are not provided herein.

In the embodiments of the present disclosure, the terms “first”, “second”, “third” are used for descriptive purposes only and should not be understood as indicating or implying relative importance; the term “a plurality of” refers to two or more, unless there is a clear definition otherwise. The terms such as “installation”, “connected”, “connection”, “fixed” should be understood in a broad sense. For example, “connection” can be a fixed connection, or a removable connection, or an integral connection; “connected” can be directly connected, or indirectly connected through an intermediary medium. For the ordinary skilled person in the art, the specific meanings of these terms in the embodiments of the invention can be understood based on the specific circumstances.

In the description of the embodiments of the present disclosure, it should be understood that the terms “upper”, “lower”, “left”, “right”, “front”, and “rear” indicate a direction or position based on the orientation or position shown in the accompanying drawings. These terms are used only to facilitate the description of the embodiment and to simplify the description, and are not intended to indicate or imply that the device or unit referred to must have a specific direction, be constructed and operated in a specific orientation. Therefore, these terms should not be construed as limiting the embodiments of the invention.

In the description of this specification, terms such as “an embodiment,” “some embodiments,” “a specific embodiment” refer to the specific features, structures, materials, or characteristics described in conjunction with the embodiment or example being included in at least one embodiment or example of the invention. In this specification, the illustrative terms do not necessarily refer to the same embodiment or example. Moreover, the specific features, structures, materials, or characteristics described may be suitably combined in any one or more of the embodiments or examples.

The above description is merely a preferred embodiment of the present disclosure and is not intended to limit the embodiment. For the person skilled in the art, the present disclosure may be subject to various changes and modifications. Any modifications, equivalent substitutions, improvements, and the like made within the spirit and principles of the embodiments of the present disclosure should be included within the scope of protection of the embodiments of the present disclosure.

We claim:

1. A relay, comprising:
a base;
a contact part disposed on the base and comprising two sets of movable contact parts, each set of the movable contact parts comprising a movable contact piece, a movable contact unit and a static contact unit, the movable contact unit being arranged on the movable contact piece; two movable contact units of the contact part corresponding to two static contact units of the contact part, respectively; wherein stiffnesses of two movable contact pieces are difference;
a push rod assembly comprising a first push rod and a second push rod, the first push rod and the second push rod being connected to the two movable contact pieces, respectively; and
a magnetic circuit part arranged on the base and configured to drive the movements of the first push rod and the second push rod in an opposite directions, so as to drive the two movable contact pieces to come into contact or move away from each other, achieving contact or separation between the static contact unit and the movable contact unit.

2. The relay according to claim 1, wherein when the contact part is in a disconnected state, a contact gap between the movable contact unit and the static contact unit corresponding to each other in one set is smaller than a contact gap between the movable contact unit and the static contact unit corresponding to each other in the other set; the movable contact unit and the static contact unit in one set with a smaller contact gap is defined as an arc-resistant end contact, and movable contact unit and the static contact unit in the other set with a larger contact gap is defined as a current-carrying end contact;
the movable contact piece provided with the movable contact unit of the current-carrying end contact is defined as a first movable contact piece, the movable contact piece provided with the movable contact unit of the arc-resistant end contact is defined as a second movable contact piece; the first push rod is connected with the first movable contact piece, the second push rod is connected with the second movable contact piece;
the stiffness of the first movable contact piece is less than the stiffness of the second movable contact piece.

3. The relay according to claim 2, wherein a thickness of the first movable contact piece is less than a thickness of the second movable contact piece.

4. The relay according to claim 3, wherein the first movable contact piece and the second movable contact piece respectively comprises a plurality of sub-contact pieces stacked with each other;
a number of the sub-contact pieces of the first movable contact piece is less than a number of the sub-contact pieces of the second movable contact piece.

5. The relay according to claim 2, wherein the movable contact unit comprises one or more movable contacts, the static contact unit comprises one or more static contacts, and the movable contacts and static contacts corresponding to each other form a contact set; the arc-resistant end contact comprises one or more contact sets, and the current-carrying end contact comprises one or more contact sets;
a number of the contact sets of the arc-resistant end contact is less than or equal to a number of the contact sets of the current-carrying end contact.

6. The relay according to claim 5, wherein the arc-resistant end contact comprises one or two contact sets; and
the current-carrying end contact comprises two or three contact sets.

7. The relay according to claim 5, wherein the arc-resistant end contact comprises two contact sets, and the two contact sets are arranged side by side in a width direction of the movable contact part;
the current-carrying end contact comprises two or three contact sets, and the two or three contact sets are arranged side by side in the width direction of the movable contact part.

8. The relay according to claim 5, wherein a slit is provided between the two movable contacts adjacent to each other on the movable contact piece in a width direction of the movable contact piece.

9. The relay according to claim 8, wherein in a length direction of the movable contact piece, one end of the slit penetrates through an end face of the movable contact piece, and the other end of the slit extends to the static contact on the movable contact piece.

10. The relay according to claim 1, wherein each set of movable contact parts further comprises a movable contact leading-out piece, the movable contact leading-out piece is connected to the movable contact piece;
the static contact unit is disposed at a connection position between the movable contact piece and the movable contact leading-out piece.

11. The relay according to claim 10, wherein the movable contact piece has a first end and a second end opposite to the first end in its own length direction;
the movable contact unit is disposed at the first end, and the second end is connected to the movable contact leading-out piece,
the first push rod and the second push rod are respectively connected with the first ends of the two movable contact pieces.

12. The relay according to claim 1, wherein the magnetic circuit part comprises a coil assembly and a armature assembly, the armature assembly is pivotally connected to the base, the armature assembly is respectively connected to the first push rod and the second push rod, the coil assembly is configured to drive the armature assembly to pivot;
the first push rod and the second push rod are located at opposite sides of the armature assembly.

13. The relay according to claim 1, wherein when the contact part is in connected state, the movable contact piece with smaller stiffness is deformed under an action of the first push rod or the second push rod and has an elastic force, the elastic force makes the movable contact piece has a moving tendency to disconnect the contacts.
